(19) United States
(12) Patent Application Publication
(10) Pub. No.: US 2026/0307338 A1
(43) Pub. Date: Oct. 8, 2026

(54) METHOD FOR ATTACHING A METAL REINFORCEMENT ON A LEADING EDGE OF A TURBOMACHINE BLADE

(71) Applicants: SAFRAN AIRCRAFT ENGINES, Paris (FR); SAFRAN AEROSPACE COMPOSITES, LLC, Rochester, NH (US); SAFRAN AIRCRAFT ENGINES MEXICO SA de C.V., Colón (MX)

(72) Inventors: Alexandre Rene Roger BEDLE, Moissy-Cramayel (FR); Grégory GARCIA, Moissy-Cramayel (FR); Cali LAPENTA, Rochester (FR); Matthieu Patrick Jean Roger PERLIN, Moissy-Cramayel (FR); Julio JUAREZ, Cólon (MX)

(73) Assignees: SAFRAN AIRCRAFT ENGINES, Paris (FR); SAFRAN AEROSPACE COMPOSITES, LLC, Rochester, NH (US); SAFRAN AIRCRAFT ENGINES MEXICO SA de C.V., Colón (MX)

(21) Appl. No.: 19/169,724

(22) Filed: Apr. 3, 2025

(51) Int. Cl. B29C 65/00; B29C 65/48; B29L 31/08; F01D 5/14

(52) U.S. Cl. CPC B29C 66/82661; B29C 65/48; F01D 5/147; B29L 2031/082; F05D 2230/23; F05D 2240/303

(57) ABSTRACT

A method including the application of adhesive on two opposite surfaces of the leading edge, positioning the metal reinforcement on the leading edge, the metal reinforcement including two fins each extending along one of the surfaces of the leading edge, positioning a polymer sheet on at least one first face of the blade so as to cover at least a first fin, positioning a pressurising device on the polymer sheet, the pressurising device being positioned facing the first fin, positioning of the blade in a vacuum bag, placing the vacuum bag under vacuum, and polymerising the adhesive.

### TECHNICAL FIELD

The present invention relates to the general field of gas turbine blades for aeronautical engines, which blades are made of composite material and, more particularly, to a method for attaching a metal reinforcement on a leading edge of a turbomachine blade, as well as to a pressurising device.

### PRIOR ART

It is known to equip the fan blades of a turbomachine, which blades are made of composite material, with a metal structural reinforcement extending over the entire height of the blade and beyond their leading edge. The same applies for output guide vanes.

Such metal reinforcements can protect the composite blade during impact on the fan of a foreign body, such as a bird ingested by the turbomachine for example. In particular, the metal reinforcements protect the leading edge of the composite-material blade by avoiding the risk of delamination, fibre breakage or damage due to fibre/matrix debonding.

In general, the metal reinforcements are titanium parts produced by milling from a block of material and which are bonded directly on the outer profile of the leading edge of the blade to be protected.

According to a conventional attachment method, the adhesive is applied on the two opposite faces of the leading edge, then the leading edge is inserted in the metal reinforcement. The metal reinforcement comprises two fins each extending along one of the faces of the leading edge.

The attachment method is conventionally carried out in a vacuum bag in an autoclave. In order to guarantee a homogeneous distribution of the pressure and to smooth out adhesive creep over all the bonding zones, at least one silicone sheet is positioned on a large part of one of the faces of the blade, corresponding to the extrados face of the blade, and on an outer face of the metal reinforcement.

It is crucial to obtain good quality bonding in order to ensure good cohesion between the fin and the leading edge and to ensure the resistance to impact on the composite blade. In order to obtain good quality bonding, it is necessary that the thickness between the fin and the leading edge, and thus the thickness of adhesive, is sufficiently fine.

However, it has been observed that geometric variations induced by the manufacture firstly of the blades and secondly of the leading edge, tend to generate variable assembly configurations. In other words, the variation in the position of the bottom of the metal reinforcement relative to the tip of the blade leads to a variation in the spacing of the fins and thus of the distance between the fins and the blade. The further away that the bottom of the metal reinforcement is from the tip of the blade, the larger the spacing of the fins.

This increase in the spacing of the fins then contributes to increase the thicknesses of adhesive between the fins and the blade, thus degrading the quality of the bonding. The pressures applied by the sheet under vacuum on the fins during the autoclave cycle are not sufficient to compensate for this increase in thickness.

### DISCLOSURE OF THE INVENTION

The invention thus aims to at least partially resolve these disadvantages by proposing a method for attaching a metal reinforcement on a leading edge of a turbomachine blade, enabling the bonding between the metal reinforcement and the leading edge of the blade to be improved by reducing the thickness between the fins of the metal reinforcement and the leading edge of the composite part of the blade.

The invention relates to a method for attaching a metal reinforcement on a leading edge of a composite structure of a turbomachine blade comprising:
applying adhesive on two opposite surfaces of the leading edge,
positioning the metal reinforcement on the leading edge, the metal reinforcement comprising two fins each extending along one of the surfaces of the leading edge,
positioning a first polymer sheet on at least one first face of the blade so as to cover the composite structure of the blade and at least one first fin,
positioning a pressurising device on the first polymer sheet, the pressurising device being positioned facing the first fin,
positioning the blade in a vacuum bag,
placing the vacuum bag under vacuum, such that the pressurising device exerts a pressure on the first fin as a consequence of the pressure exerted by the vacuum bag on the pressurising device, and
polymerising the adhesive.

The invention thus provides a method for attaching a metal reinforcement on a leading edge of a turbomachine blade which can improve the bonding between the metal reinforcement and the leading edge of the blade.

The addition of the pressurising device on the first polymer sheet enables an additional pressure to be applied on the surface of the fins of the metal reinforcement which is added to the pressure exerted by the first polymer sheet on the surface of the fins of the metal reinforcement during placing under vacuum in an autoclave.

The first polymer sheet is preferably made of silicone.

The pressure is applied uniformly on the surface of the fins, reducing the thickness between the fins of the metal reinforcement and the leading edge. It is thus possible to obtain a thickness of adhesive of between 100 μm and 350 μm.

Thus, the thickness of adhesive between the fins of the metal reinforcement and the leading edge is substantially constant from one blade to another, whatever the position of the bottom of the metal reinforcement relative to the tip of the blade, and therefore whatever the spacing of the fins relative to the blade.

The pressurising device matches the shape of the blade and is made of a harder material than silicone. The pressurising device amplifies the pressure applied on the fin and therefore better presses it on the composite structure of the blade during placing under vacuum and the application of an overpressure in the autoclave. Placing the pressure device on the silicone sheet makes it possible to homogenise the effects of too local pressure and bridging, which could have an undesirable effect on bonding.

This method is particularly useful for bonding the fin on the extrados face of the blade but can also be applied on the intrados face of the blade.

Ultrasonic checks carried out after the bonding process, show that there are less anomalies linked to the overpressure/under-thickness of adhesive or pores.

In certain embodiments, the pressurising device is positioned on the first polymer sheet, so as to extend along a step formed on an outer face of the first polymer sheet, facing a longitudinal end of the first fin.

In certain embodiments, the pressurising device is positioned at a distance d from the step, the distance d being greater than or equal to 0 and less than or equal to 5 mm.

This distance avoids bridging effects of the pressurising device with the composite structure.

The pressurising device can be positioned at the limit of the step but must not go beyond it.

In certain embodiments, the pressurising device extends from a tip of the blade to a root of the blade.

In certain embodiments, the method comprises a step of holding the pressurising device on the first polymer sheet and a step of attaching the pressurising device on the first polymer sheet.

In certain embodiments, the method comprises, after the step of placing the vacuum bag under vacuum, a step of positioning the vacuum bag in an autoclave, a pressure greater than 2 bar and a temperature greater than 140° C. being applied in the autoclave.

In certain embodiments, during the positioning of the pressurising device, a pressurising tool of the pressurising device is positioned on a convex part of one of the surfaces of the leading edge of the blade, and a complementary pressurising tool of the pressurising device is positioned on a concave part of the surface of the leading edge of the blade.

In certain embodiments, the method comprises a step of positioning a first pressurising device on the first polymer sheet, a step of positioning a second polymer sheet on a second face of the blade so as to cover the composite structure of the blade and at least one second fin of the metal reinforcement, and a second step of positioning a second pressurising device on the second polymer sheet, facing the second fin.

In certain embodiments, the first and second pressurising devices extends from a tip of the blade to a root of the blade.

In certain embodiments, the method comprises a step of holding the pressurising device on the first polymer sheet, a step of attaching the pressurising device on the first polymer sheet, a step of holding the second pressurising device on the second polymer sheet and a step of attaching the second pressurising device on the second polymer sheet.

In certain embodiments, the method comprises, after the step of placing the vacuum bag under vacuum, a step of positioning the vacuum bag in an autoclave, a pressure greater than 2 bar and a temperature greater than 140° C. being applied in the autoclave.

The invention also relates to a pressurising device for bonding a metal reinforcement on a leading edge of a turbomachine blade, comprising at least one elongate-shaped pressurising tool configured to apply a pressure on a fin of the leading edge during an operation of attaching the metal reinforcement on the leading edge, the pressurising tool comprising at least one portion having a polygonal-shaped cross-section.

Through the trapezoidal cross-section of the pressurising tool, the vacuum bag is supported on a large surface of the pressurising tool during the placing under vacuum, making it possible to apply a significant pressure on the faces of the pressurising tool. This trapezoidal shape also prevents the vacuum bag from tearing.

In certain embodiments, the pressurising device comprises a complementary pressurising tool intended to be positioned facing the pressurising tool, the complementary pressurising tool having a generally triangular shape and comprising transverse ribs.

The triangular shape of the complementary pressurising tool enables a larger pressure to be obtained on the second fin in the concave part of the blade.

In certain embodiments, the pressurising tool comprises a first portion having a triangular cross-section and a second portion comprising longitudinal ribs.

In certain embodiments, the surface of the pressurising arrangement in contact with the first polymer sheet is relatively smooth.

In certain embodiments, the surface of the pressurising device in contact with the first polymer sheet (pressurising surface) corresponds to the useful surface necessary for applying a uniform pressure on the desired surface of the first fin. The useful surface corresponds to a surface facing a zone coated with adhesive between the first fin and the surface of the leading edge.

In certain embodiments, the pressurising surface is less than or equal to the surface facing of the zone to be bonded.

The above-mentioned features and advantages, as well as others, will become apparent on reading the detailed description which follows. This detailed description refers to the attached drawings.

### BRIEF DESCRIPTION OF THE DRAWINGS

The attached drawings are schematic and primarily aim to illustrate the principles of the disclosure.

In these drawings, from one figure to another, identical elements (or parts of elements) are identified by the same reference signs.

FIG. 1 schematically represents a face of a blade covered by a first polymer sheet and on which a first pressurising device is disposed, according to an embodiment of the invention;

FIG. 2 schematically represents a cross-section of the blade of FIG. 1;

FIG. 3 schematically represents another face of a blade covered by a second polymer sheet and on which a second pressurising device is disposed, according to another embodiment of the invention.

### DESCRIPTION OF THE EMBODIMENTS

In order to make the disclosure more concrete, an example of an attachment method is described in detail below, with reference to the attached drawings. It is recalled that the invention is not limited to this example.

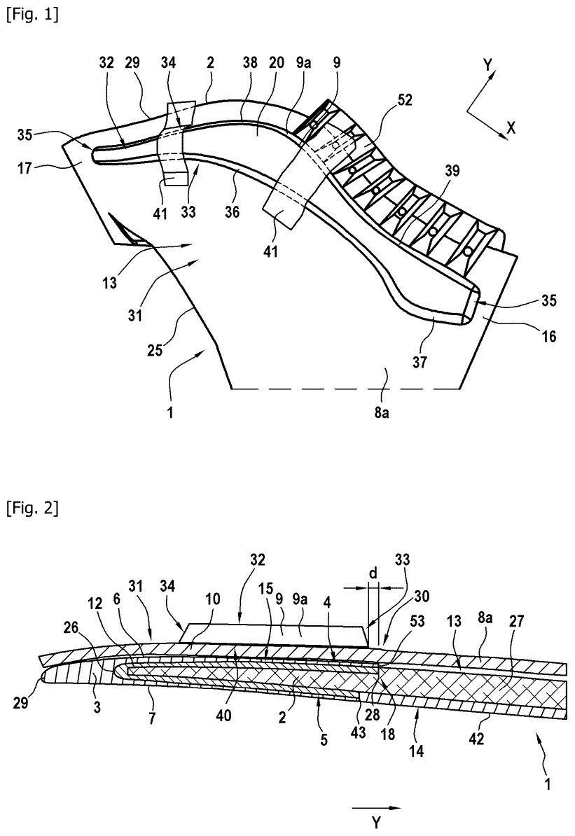

The invention applies to any composite-material gas turbine blade for an aeronautical engine, and in particular to turbomachine fan blades 1, such as those shown in FIGS. 1 to 3.

In known manner, the fan blade 1 has an aerodynamic surface which extends between a leading edge 2 and a trailing edge 25. The aerodynamic surface of the blade 1 also comprises a first face 13 which corresponds in the example to an extrados face, and a second face 14 which corresponds in the example to an intrados face. These faces 13, 14 form the lateral faces of the blade 1 connecting the leading edge 2 to the trailing edge 25.

The blade 1 comprises a composite structure 27 which is made of composite material with a fibrous reinforcement densified by a matrix. For example, the composite structure 25 can be produced by three-dimensional weaving of a fibrous preform and impregnation of the preform by a matrix, the assembly being formed by moulding using vacuum assisted resin transfer moulding VARTM.

The blade 1 comprises a metal reinforcement 3, also known as a structural metal reinforcement, which is bonded on the composite structure 27 at its leading edge 2 and which extends both axially beyond the leading edge 2 and radially over the entire height of the leading edge 2, in other words from the root 17 to the tip 16 of the blade 1. The metal reinforcement 3 forms a metal leading edge connected on the leading edge 2 of the composite structure 27.

The blade 1 extends substantially in a longitudinal direction X. The leading edge 2 comprises a first surface 4 and a second surface 5 which extend in a transverse direction Y, perpendicular to the longitudinal direction X, towards the trailing edge 25.

More precisely, the metal reinforcement 3 matches the shape of the leading edge 2 of the composite structure 27, which it extends in order to form a metal leading edge. Beyond the leading edge 2, the metal reinforcement 3 partially matches the profile of the first and second surfaces 4, 5. The metal reinforcement 3 has a straight section substantially in the shape of a rounded V with a bottom 26 matching the leading edge 2 and prolonged by two lateral flanks or two fins 6, 7, including a first fin 6 matching the first surface 4 of the leading edge 2 and a second fin 7 matching the second face 5 of the leading edge 2.

The first fin 6 extends along the first surface 4 of the leading edge 2 and the second fin 7 extends along the second surface 5 of the leading edge 2, opposite the first surface 4.

The fins 6, 7 of the metal reinforcement 3 have a profile that thins towards the trailing edge 25. The metal reinforcement 3 is a single piece, preferably produced from titanium. This material has a high capacity to absorb energy due to shocks.

The metal reinforcement 3 is bonded on the leading edge 2 of the blade 1 by means of an attachment method according to the invention which is described below in conjunction with FIGS. 1 to 3.

The attachment method comprises a step of applying adhesive 12 on the two opposite surfaces 4, 5 of the leading edge 2. The adhesive 2 can be a polymer of the polyester, polyurethane, polyepoxide, bismaleimide and/or phenolic type and is in the form of a paste. Preferably, the thickness of the adhesive 12 is between 100 μm and 350 μm.

The composite structure 27 comprises a shoulder 28 forming a step which is generated after a burring operation on the composite structure 27. This step is a projection of the composite structure 27 enabling the thickness of the first fin 6 of the leading edge 2 to be resumed.

The attachment method then comprises a step of positioning the leading edge 2 in the metal reinforcement 3. The first fin 6 extends along (above) the first surface 4 of the leading edge 2 following the transverse direction Y, to the shoulder 28.

The first fin 6 comprises a longitudinal end 53 which extends in the longitudinal direction X. The longitudinal end 53 is facing the shoulder 28 and runs along the shoulder 28 so as to form a junction line 18 between the first fin 6 and the composite structure 27 of the blade 1.

The second fin 7 extends along (above) the second surface 5 of the leading edge 2 in the transverse direction Y, up to a polyurethane film 42.

The attachment method then comprises a step of positioning a first polymer sheet 8a on the first face 13 of the blade 1, so as to cover the composite structure 27 of the blade 1 and at least the first fin 6. The first polymer sheet 8a covers an outer surface 15 of the metal reinforcement 3. The first polymer sheet 8a extends to an end 29 of the metal reinforcement 3. The first polymer sheet 8a entirely, or almost entirely, covers the first face 13 of the blade 1 and therefore the junction line 18.

The first polymer sheet 8a is preferably a silicone sheet.

The first face 13 of the blade 1 can be completely or partially covered with a single polymer sheet or several polymer sheets. The term “first polymer sheet 8a” shall mean a sheet comprising a single polymer sheet or even a plurality of polymer sheets.

The thickness of the first fin 6 being larger than the height of the shoulder 28, a step 30 is formed on an outer face 31 of the first polymer sheet 8a. The step 30 extends in the longitudinal direction X from the tip 16 to the root of the blade 1.

The attachment method then comprises a step of positioning one or more pressurising devices 9, 19, 20 on the fins 6, 7.

In the example of FIGS. 1 and 2, only a first pressurising device 9 is positioned on the first polymer sheet 8a covering the first face 13 (extrados face) of the blade 1. The first pressurising device 9 is positioned facing the first fin 6.

The first pressurising device 9 comprises an elongate shaped first pressurising tool 9a, having a trapezoidal cross-section.

The first pressurising tool 9a comprises an outer face 32 connected to a first longitudinal face 33 and to a second longitudinal face 34, opposite the first longitudinal face 33. The longitudinal faces 33, 34 are inclined with respect to the upper face 32 at an angle greater than 90° and less than 180°, and preferably approximately 100°.

The upper face 32 is flat overall. The first pressurising tool 9a comprises two lateral faces 35 each connected to the two longitudinal faces 33, 34. The two lateral faces 35 have a trapezoidal shape

The first pressurising tool 9a comprises an inner face 40, opposite the outer face 32, in contact with the first polymer sheet 8a. The inner face 40 is substantially smooth and is the counter-shape of the first face 13 of the blade 1.

The first pressurising tool 9a has a hardness greater than that of the first polymer sheet 8a which is made of silicone. The first pressurising tool 9a can be made of polymer or of metal such as aluminium.

As illustrated in FIG. 1, the first pressurising tool 9a extends along entire length of the blade 1 from the tip 16 to the root 17 of the blade 1. The first pressurising tool 9a matches the shape of the first face 13 of the blade 1.

The first pressurising tool 9a is positioned on the first polymer sheet 8a so as to extend along the step 30. The first longitudinal face 33 of the pressurising tool 9a runs along the step 30 and matches the shape of the step 30 in the longitudinal direction X. The first longitudinal face 33 comprises a concave portion 36 and a convex portion 37.

The second longitudinal face 34 of the pressurising tool 9a runs along the tip 29 of the metal reinforcement 3 and matches its shape in the longitudinal direction X. The second longitudinal face 34 comprises a convex portion 38 positioned facing the concave portion 36 of the first longitudinal face 33 and a concave portion 39 running along a part of the concave portion 36 of the first longitudinal face 33 and the convex portion 37 of the first longitudinal face 33.

The first pressurising tool 9a is positioned at a distance d from the step 30. The distance d is greater than or equal to 0 and less than or equal to 5 mm.

Preferably, the first pressurising tool 9a does not extend to the tip 29 of the metal reinforcement 3.

Preferably, the first pressurising tool 9a does not extend to the bottom 26 of the metal reinforcement 3. The first pressurising tool 9a covers between ⅓ and ⅔ of the metal reinforcement 3.

The first pressurising tool 9a has a thickness of between 5 mm and 15 mm.

The attachment method then comprises a step of holding the first pressurising tool 9a on the first polymer sheet 8a by means of two holding tools, a first holding tool of which is positioned at the tip 16 of the blade 1 and a second holding tool positioned at the root 17 of the blade 1. The holding tools comprise a first part bearing against the first pressurising tool 9a and a second part bearing against a second face 14 of the blade 1 in order to clamp the first pressurising tool 9a against the first polymer sheet 8a, in other words against the first surface 13 of the blade 1.

The attachment method then comprises a step of attaching the first pressurising tool 9a on the first polymer sheet 8a by means of a plurality of adhesive tapes 41 attached on the first pressurising tool 9a and on the first polymer sheet 8a.

The step of holding the first pressurising tool 9a ensures correct positioning of the first pressurising tool 9a before applying the step of attaching the first pressurising tool 9a.

In an alternative, a stiffening device 52 can be positioned on the leading edge 2 of the composite structure 27 in order to stiffen the composite structure 27 during the process of attaching the metal reinforcement 3.

The attachment method then comprises a step of positioning the blade 1 covered by the first polymer sheet 8a and the first pressurising tool 9a in a vacuum bag.

The vacuum bag is introduced into an autoclave.

The attachment method then comprises a step of placing the vacuum bag under vacuum so that the vacuum bag exerts a pressure on the first fin 6 as a consequence of the pressure exerted by the vacuum bag on the first pressurising tool 9a. The vacuum is applied under a pressure of approximately 1 bar.

An overpressure is also applied in the autoclave by means of a gas. The pressure is approximately 4 bar, for example.

The first polymer sheet 8a can ensure a homogeneous distribution of the pressure on the first fin 6 and can smooth out adhesive creep over all the bonding zones between the first fin 6 and the first surface 4 of the leading edge 2.

The addition of the first pressurising tool 9a on the first polymer sheet 8a enables an additional pressure to be applied on the first surface of the first fin 4 of the metal reinforcement 3, which is added to the pressure exerted by the first polymer sheet 8a on the first surface of the first fin 4 during placing under vacuum. The overpressure in the autoclave also makes it possible to exert a pressure on the vacuum bag and therefore on the first pressurising tool 9a.

The first pressurising tool 9a can also apply a uniform pressure on the surface of the first fin 6, reducing the thickness between the first fin 6 and the leading edge 2.

Through the trapezoidal shape of the first pressurising tool 9a, the vacuum bag bears on a large surface of the first pressurising tool 9a during the placing under vacuum, making it possible to apply a significant pressure on the faces of the first pressurising tool 9a. This trapezoidal shape, without acute angles, also prevents the vacuum bag from tearing.

The attachment method then comprises a step of polymerising the adhesive 12 through a heating operation in the autoclave, enabling the respective fins 6, 7 of the blade 1 to be bonded on the first and second faces 13, 14.

In the case of an epoxy adhesive, classed as 180° C., the polymerisation is carried out by raising the temperature to 140° C. for 2 hours, for example.

After cooling, the vacuum bag is removed from the autoclave. The blade 1 is removed from the vacuum bag. The first pressurising tool 9a and the first polymer sheet 8a are removed from the blade 1.

The second face 14 of the composite structure 27 of the blade 1 comprises a polyurethane film 42 extending over the entire second face 14 to a second longitudinal end 43 of the second fin 7.

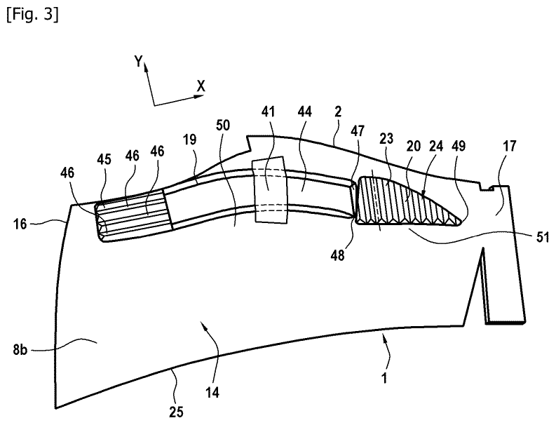

In a variant, the attachment method comprises a step of positioning a second polymer sheet 8b on the second face 14 of the blade 1 so as to cover the composite structure 27 of the blade 1 and at least the second fin 7, as illustrated in FIG. 3. The second polymer sheet 8b extends to the tip 29 of the metal reinforcement 3.

The placing under vacuum and polymerisation are carried out in the same way as for the preceding embodiment.

In a variant, the attachment method comprises a first step of positioning a first pressurising device 9 on the first polymer sheet 8a facing the first fin 6, and a second step of positioning a second pressurising device 19, 20 on the second polymer sheet 8b, facing the second fin 7.

The first pressurising device 9 comprises a first pressurising tool 9a as previously described and covering the first polymer sheet 8a on the side of the first face 13 of the blade 1.

The second pressurising device 19, 20 comprises a second pressurising tool 19 and a complementary pressurising tool 20, as illustrated in FIG. 3.

The second pressurising tool 19 is positioned on the second polymer sheet 8b so as to extend along the second longitudinal end 43 of the second fin 7.

The second pressurising tool 19 matches the shape of the second longitudinal end 43 in the longitudinal direction X. The second pressurising tool 19 also matches the shape of the second face 14 of the blade 1.

The second pressurising tool 19 is positioned at a distance from the second longitudinal end 43 which is greater than or equal to 0 and less than or equal to 5 mm.

The second pressurising tool 19 comprises a first portion 44 having a triangular cross-section and a second portion 45 comprising longitudinal ribs 46. The first portion 44 is at least twice as long as the second portion 45 which is positioned facing the tip 16 of the blade 1. The second portion 45 comprises three longitudinal ribs 46, by way of example, which extend in the longitudinal direction X. The second pressurising tool 19 is curved.

The complementary pressurising tool 20 is positioned on the second polymer sheet 8b facing the second fin 7 and facing the root 17 of the blade 1.

The complementary pressurising tool 20 comprises a base 48, which is positioned facing one end 47 of the first portion 44 of the second pressurising tool 19, and a tip 49 positioned facing the root 17 of the blade 1.

The complementary pressurising tool 20 has a generally triangular shape and comprises transverse ribs 23 on an outer face 24. The transverse ribs 23 extend in the transverse direction Y and enable the complementary pressurising tool 20 to be stiffened.

The second pressurising tool 19 is positioned on a convex part 50 of the second surface 5 of the leading edge 2 of the blade 1, and the complementary pressurising tool 20 is positioned on a concave part 51 of the second surface 5 of the leading edge 2 of the blade 1. The triangular shape of the complementary pressurising tool 20 enables a larger pressure to be obtained on the second fin 7 in the concave part 51.

The second pressurising tool 19 is more flexible than the complementary pressurising tool 20 in order to match the shape of the convex part 50 of the second surface 5 of the leading edge 2 of the blade 1. The complementary pressurising tool 20 is rigid. The second pressurising tool 19 and the complementary pressurising tool 20 are made of silicone, for example, the complementary pressurising tool 20 being made of a denser silicone than the silicone of the second pressurising tool 19.

The second pressurising tool 19 is approximately three times as large as the complementary pressurising tool 20.

As for the preceding embodiment, the attachment method comprises a step of holding the second pressurising tool 19 and the complementary pressurising tool 20 on the second polymer sheet 2b using holding tools such as previously described.

The attachment method then comprises a step of attaching the second pressurising tool 19 and the complementary pressurising tool 20 on the second polymer sheet 8b using a plurality of adhesive tapes 41 attached on the second pressurising tool 19, the complementary pressurising tool 20 and the second polymer sheet 8b.

The attachment method then comprises a step of positioning the blade 1 covered with the two silicone sheets 8a, 8b and two pressurising devices 9, 19, 20 in a vacuum bag.

The vacuum bag is introduced into an autoclave.

The attachment method then comprises a step of placing the vacuum bag under vacuum so that the first pressurising tool 9a exerts a pressure on the first fin 6 as a consequence of the pressure exerted by the vacuum bag on the first pressurising tool 9a, and so that the second pressurising tool 19 and the complementary pressurising tool 20 exert a pressure on the second fin 7 as a consequence of the pressure exerted by the vacuum bag on the second pressurising tool 19 and on the complementary pressurising tool 20.

An overpressure is also applied in the autoclave by means of a gas. The pressure is approximately 4 bar, for example. The temperature applied in the autoclave is greater than 140° C.

The attachment method then comprises a step of polymerising the adhesive 12 through a heating operation in the autoclave, enabling the respective fins 6, 7 of the blade 1 to be bonded on the first and second faces 13, 14.

In a variant, the attachment method may comprise only a step of positioning the second pressurising device 19, 20 on the second polymer sheet 8b, facing the second fin 7, without using the first pressurising device 9.

In other words, the first and second faces 13, 14 of the blade 1 may each comprise a pressurising device 9, 19, 20, or only one of the faces 13, 14 of the blade 1 may comprise a pressurising device 9, 19, 20 during the polymerisation of the adhesive in the autoclave.

Although the present invention has been described by referring to specific exemplary embodiments, it is obvious that modifications and changes can be made to these examples without going beyond the general scope of the invention as defined by the claims. In particular, the individual features of different embodiments illustrated or mentioned can be combined in additional embodiments. Consequently, the description and the drawings should be considered as illustrating rather than limiting.

It is also obvious that all the features described in reference to a method can be transposed, alone or in combination, to a device, and inversely, all the features described in reference to a device can be transposed, alone or in combination, to a method.

1. A method for attaching a metal reinforcement on a leading edge of a composite structure of a turbomachine blade comprising:
applying adhesive on two opposite surfaces of the leading edge,
positioning the metal reinforcement on the leading edge, the metal reinforcement comprising two fins each extending along one of the surfaces of the leading edge,
positioning a first polymer sheet on at least one first face of the blade so as to cover the composite structure of the blade and at least one first fin,
positioning a pressurising device on the first polymer sheet, the pressurising device being positioned facing the first fin,
positioning the blade in a vacuum bag,
placing the vacuum bag under vacuum, such that the pressurising device exerts a pressure on the first fin as a consequence of the pressure exerted by the vacuum bag on the pressurising device, and
polymerising the adhesive.

2. The method according to claim 1, wherein the pressurising device is positioned on the first polymer sheet so as to extend along a step formed on an outer face of the first polymer sheet, facing a longitudinal end of the first fin.

3. The method according to claim 2, wherein the pressurising device is positioned at a distance d from the step, the distance d being greater than or equal to 0 and less than or equal to 5 mm.

4. The method according to claim 1, wherein the pressurising device extends from a tip of the blade to a root of the blade.

5. The method according to claim 1, comprising a step of holding the pressurising device on the first polymer sheet and a step of attaching the pressurising device on the first polymer sheet.

6. The method according to claim 1, comprising, after the step of placing the vacuum bag under vacuum, a step of positioning the vacuum bag in an autoclave, a pressure greater than 2 bar and a temperature greater than 140° C. being applied in the autoclave.

7. The method according to claim 1, comprising a step of positioning a first pressurising device on the first polymer sheet, a step of positioning a second polymer sheet on a second face of the blade so as to cover the composite structure of the blade and at least one second fin of the metal reinforcement, and a second step of positioning a second pressurising device on the second polymer sheet, facing the second fin.

8. The method according to claim 7, wherein the first and second pressurising devices extend from a tip of the blade to a root of the blade.

9. The method according to claim 7, comprising a step of holding the pressurising device on the first polymer sheet, a step of attaching the pressurising device on the first polymer sheet, a step of holding the second pressurising device on the second polymer sheet and a step of attaching the second pressurising device on the second polymer sheet.

10. The method according to claim 7, comprising, after the step of placing the vacuum bag under vacuum, a step of positioning the vacuum bag in an autoclave, a pressure greater than 2 bar and a temperature greater than 140° C. being applied in the autoclave.

11. A pressurising device for bonding a metal reinforcement on a leading edge of a turbomachine blade, comprising at least one elongate-shaped pressurising tool configured to apply a pressure on a fin of the leading edge during an operation of attaching the metal reinforcement on the leading edge, the pressurising tool comprising at least one portion having a polygonal-shaped cross-section.

12. The pressurising device according to claim 11, comprising a complementary pressurising tool intended to be positioned facing the pressurising tool, the complementary pressurising tool having a generally triangular shape and comprising transverse ribs.

13. The pressurising device according to claim 11, wherein the pressurising tool comprises a first portion having a triangular cross-section and a second portion comprising longitudinal ribs.
